(19) United States
(12) Patent Application Publication
(10) Pub. No.: US 2026/0187647 A1
(43) Pub. Date: Jul. 2, 2026

(54) AUTOMATED MECHANISM TO SIMULATE CONTACT-CENTER INTERACTION PERSONAS

(71) Applicant: eBay Inc., San Jose, CA (US)

(72) Inventors: Subrahmanya Satya KARI, Austin, TX (US); Praveen Kumar KATAKAM, Leander, TX (US)

(21) Appl. No.: 19/007,294

(22) Filed: Dec. 31, 2024

(51) Int. Cl. G06Q 30/015; G06N 3/006

(52) U.S. Cl. CPC G06Q 30/015; G06N 3/006

(57) ABSTRACT

Some aspects relate to technologies for generating persona simulators and employing the persona simulators for interaction simulation. The persona simulators can comprise user persona simulators that act as end users during simulated interactions and agent persona simulators that act as agent users during simulated interactions. To generate a persona simulator, interaction data for an end user or an agent user is accessed. The interaction data can be based on, for instance, transcript(s) from interaction(s) involving the end user or agent user. Parameter scores for different interaction parameters are generated from the interaction data, and in some cases, the parameter scores are used to determine an index score. The scores define the persona of the end user or agent user and are used to provide an input to a generative model to provide a persona simulator. The persona simulator is then used to generate text for messages during a simulated interaction.

### BACKGROUND

Many business entities provide contact centers for customer service in which agent users (i.e., customer server agents) handle a variety of interactions with end users (i.e., customers). This can be via a number of different channels, such as voice chats and text chats. The agent users are humans who have been trained to assist end users with various issues, such as inquiries, technical support, billing issues, and other concerns. The goal of contact centers is to resolve customer issues promptly and effectively.

### SUMMARY

Some aspects of the present technology relate to, among other things, a system that leverages artificial intelligence (AI) to facilitate interaction simulation via persona simulators. The persona simulators can comprise generative models that have been instructed or otherwise guided to generate text in accordance with given personas. As used herein, a “persona” refers to a representation of a given user's behavior, as exhibited by interaction data such as transcripts from interactions involving that user. A “user persona” refers to a representation of a given end user's behavior, while an “agent persona” refers to a representation of a given agent user's behavior. Accordingly, some aspects of the technology described herein provide user persona simulators for user personas that act as end users during simulated interactions, and some aspects provide agent persona simulators for agent personas that act as agent users during simulated interactions.

In accordance with some aspects of the technology described herein, the system stores interaction data for interactions between end users and agent users. To generate a persona simulator for a given end user or agent user, the system accesses interaction data for that end user or agent user. The interaction data can be based on, for instance, one or more transcripts from interaction(s) involving the end user or agent user. Based on the interaction data, the system determines parameter scores for a number of interaction parameters. The system can also determine an index score as a function of the parameter scores. The parameter scores and/or index score define a persona—a user persona in the case of an end user or an agent persona in the case of an agent user. Input is provided to a generative model based on the scores to generate a user persona simulator that exhibits the user persona (in the case of an end user) or an agent persona simulator that exhibits the agent persona (in the case of an agent user). In some aspects, this comprises generating one or more prompts using one or more rules providing different pre-defined text for different scores, and providing the prompt(s) as input to the generative model. Once generated, the persona simulator is used to generate text for messages during a simulated interaction. In some cases, this can involve a simulated interaction between a persona simulator (either a user persona simulator or an agent persona simulator) and an agent user, or a simulated interaction between two persona simulators (e.g., a simulated interaction between a user persona simulator and an agent persona simulator).

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a diagram illustrating an example scores for an end user, including a user index score and parameter scores, in accordance with some implementations of the present disclosure;

FIG. 3 is a diagram illustrating prompt data that can be used to generate a prompt in accordance with some implementations of the present disclosure;

FIG. 4 is a diagram illustrating a chat interface for a simulated interaction in accordance with some implementations of the present disclosure;

FIG. 5 is a diagram illustrating another chat interface for a simulated interaction in accordance with some implementations of the present disclosure;

FIG. 6 is a block diagram showing overall process to generate a persona simulator and employ the persona simulator for a simulated interaction in accordance with some implementations of the present disclosure;

FIG. 7 is a flow diagram showing a method for generating a persona simulator for a persona and employing the persona simulator for a simulated interaction in accordance with some implementations of the present disclosure; and

FIG. 8 is a block diagram of an exemplary computing environment suitable for use in implementations of the present disclosure.

### DETAILED DESCRIPTION

### Overview

Existing approaches to training agent users (i.e., customer service agents) present a number of shortcomings. One issue is the lack of personalization in training programs, which can result in agent users not receiving the specific skills they need for their roles. Additionally, many training programs are too short and fail to provide ongoing support, leaving agent users unprepared for complex or evolving customer issues. Furthermore, insufficient focus on soft skills, such as empathy and active listening, can lead to poor customer interactions. Finally, the absence of real-world practice opportunities means agent users might struggle to apply their training in actual customer service scenarios, reducing their overall effectiveness.

One approach to provide agent users with opportunities to develop their skills is interaction simulation. Interaction simulation involves creating realistic, controlled scenarios where agent users can practice handling diverse types of interactions with end users (i.e., customers). One challenge for interaction simulation is providing different scenarios that cover a wide range of issues and a spectrum of end user personalities. To address this issue, artificial intelligence (AI) has been more recently employed in an attempt to provide interaction simulation covering different scenarios. However, there are a number of shortcomings with existing AI approaches for interaction simulation. For instance, some current approaches employ generic pre-trained large language models (LLMs) to act as end users during simulated interactions. Such LLMs are not optimized for interaction simulation and, as such, it is difficult to get the LLMs to adequately cover the wide range of customer issues and personalities that agent users might encounter. Generic LLMs are trained on broad datasets and may not have the specific knowledge or context needed to accurately simulate diverse customer interactions. This can lead to unrealistic scenarios that do not effectively prepare agent users for real-world situations. Additionally, these models are prone to hallucinations, where they generate responses that are factually incorrect or nonsensical. This can undermine the training process by providing agent users with misleading information. Furthermore, generic LLMs may lack the ability to adapt to the specific language, tone, and style of a particular business entity's customer base, making the simulated interactions less relevant and effective.

Aspects of the technology described herein address the shortcomings of current approaches to using generative AI, such as pre-trained LLMs, for interaction simulation. More particularly, aspects involve a system that leverages AI to facilitate simulated interactions using persona simulators. These persona simulators are generative models designed to generate text in accordance with specific personas. As used herein, a “persona” refers to a representation of a given user's behavior, as exhibited by interaction data such as transcripts from interactions involving that user. A “user persona” refers to a representation of a given end user's behavior, while an “agent persona” refers to a representation of a given agent user's behavior. Accordingly, some aspects of the technology described herein provide user persona simulators for user personas that act as end users during simulated interactions, and some aspects provide agent persona simulators for agent personas that act as agent users during simulated interactions.

To generate a persona simulator for a given end user or agent user, the system accesses interaction data from one or more previous interactions involving that end user or agent user. The interaction data includes any data from one or more interactions between a user and the system, such as an interaction between an end user and an agent user. For instance, the interaction data can be text from transcript(s) from previous interaction(s) involving the user. The interaction data can include additional information regarding interactions beyond the text from transcripts. For instance, the interaction data can comprise information generated from the interactions, such as number of reconnects, time length of the interaction, sentiment, etc. The interaction data can also be tagged with an indication of the end user (e.g., an end user identifier) and an indication of one or more agent users (e.g., agent identifiers) involved in each interaction. In some aspects, the interaction data is processed using a redaction mechanism that removes any personally-identifiable information (PII) and sensitive data.

The system analyzes the interaction data to determine parameter scores for various interaction parameters. Different types of interaction parameters can be used depending on the use case, role, domain, or purpose of interaction simulation. For instance, in the case of an end user, the interaction parameters could relate to customer satisfaction, interaction history sentiment, and resolution success, to name a few. In some aspects, the system also determines an index score for the end user (i.e., a user index score) or the agent user (i.e., an agent index score) as a function of the parameter scores. For instance, the parameter scores could comprise weights that are applied to normalized parameter values and aggregated to provide the index score. The scores are used to define a persona, which can be a user persona in the case of an end user or an agent persona in the case of an agent user.

The system uses the scores to provide input to a generative model to provide a persona simulator (i.e., a user persona simulator in the case of an end user, or an agent persona simulator in the case of an agent). In some aspects, this includes generating one or more prompts with text selected based on rules that map different parameter scores to different pre-defined text portions. For example, a high parameter score for an interaction history abuse parameter could result in a prompt indicating that the persona is “very abusive and harsh;” while a low parameter score for that interaction parameter could result in a prompt indicating that the persona is “not abusive but slightly frustrated.” The prompt(s) provide text that instructs or otherwise guides the generative model to produce text that reflects the persona during simulated interactions. In some aspects, example transcripts are also provided to help guide the generative model. Accordingly, the generated persona simulator comprises the generative model that has been instructed to exhibit behavior consistent with the persona.

Once generated, persona simulators are used to provide simulated interactions that present realistic interaction scenarios. Each simulated interaction involves at least two participants—an end user and an agent user—in which a persona simulator acts as at least one of the participants. In some aspects, a simulated interaction is provided between an agent user and a persona simulator. This can include a user persona simulator acting as the end user of the simulated interaction and an agent user acting the agent user of the simulated interaction. In other instances, this can include an agent persona simulator acting as the agent user of the simulated interaction and the agent user acting as the end user in the simulated interaction. In other aspects, a simulated interaction is provided between two persona simulators. In such instances, a user persona simulator acts as the end user of the simulated interaction, and an agent persona simulator acts as the agent user of the simulated interaction.

Aspects of the technology described herein provide a number of technical improvements over existing technologies. For instance, the technology described herein provides a solution that addresses limitations of using models (e.g., generic LLMs) for interaction simulation. Among other things, the use of scores (e.g., parameter scores and index scores) derived from interaction data from real-world interactions provides a structured way to define different personas. The scores in conjunction with rules providing pre-defined text for instructing a generative model provides a structured approach that reduces hallucinations and ensures the generation of relevant responses. Additionally, the use of example transcripts further enhances the relevance and accuracy of the persona simulators'responses, while minimizing the occurrence of hallucinations. The system's ability to model various personas based on historical interactions for different end users and/or agent users allows for the creation of diverse persona simulators that can cover a wide range of scenarios, including different customer issues and end user personalities. This flexibility improves the training and preparedness of customer service agents by enabling more realistic and effective simulated interactions.

### Example System for Automated Persona Simulations

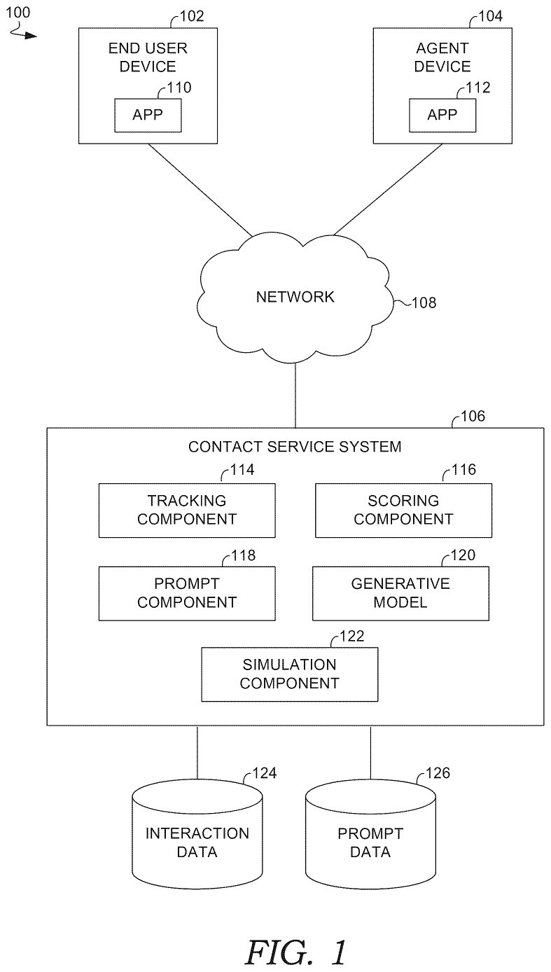

With reference now to the drawings, FIG. 1 is a block diagram illustrating an exemplary system 100 for generating persona simulators from interaction data and employing the person simulators for simulated interactions in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

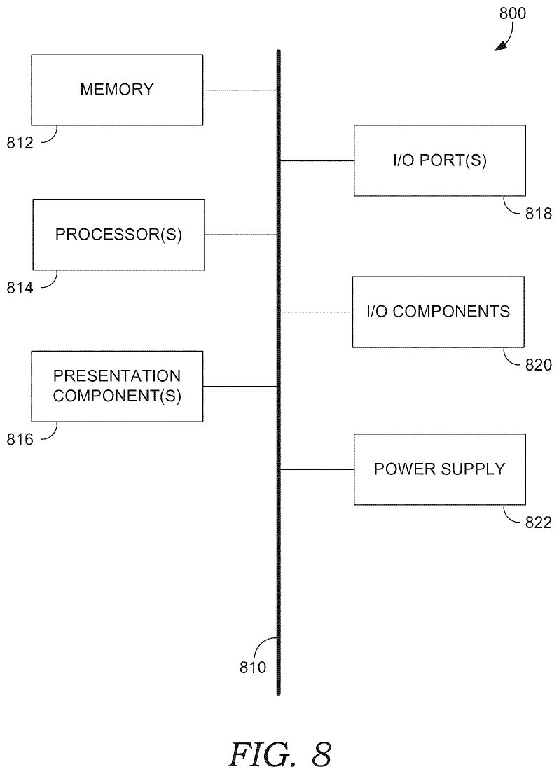

The system 100 is an example of a suitable architecture for implementing certain aspects of the present disclosure. Among other components not shown, the system 100 includes an end user device 102, an agent device 104, and a contact service system 106. Each of the end user device 102, the agent device 104, and the contact service system 106 shown in FIG. 1 can comprise one or more computer devices, such as the computing device 800 of FIG. 8, discussed below. As shown in FIG. 1, the end user device 102, the agent device 104, and the contact service system 106 can communicate via a network 108, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the contact service system 106 could be provided by multiple server devices collectively providing the functionality of the contact service system 106 as described herein. Additionally, other components not shown may also be included within the network environment.

The end user device 102 and the agent device 104 can each be a client device on the client-side of the system 100, while the contact service system 106 can be on the server-side of the system 100. The contact service system 106 can comprise server-side software designed to work in conjunction with client-side software on the end user device 102 and the agent device 104 so as to implement any combination of the features and functionalities discussed in the present disclosure. For instance, the end user device 102 can include an application 110 and the agent device 104 can have an application 112 for interacting with the contact service system 106. The application 110 and the application 112 can each be, for instance, a web browser or a dedicated application for providing functions, such as those described herein. This division of the system 100 is provided to illustrate one example of a suitable environment, and there is no requirement for each implementation that any combination of the end user device 102, the agent device 104, and/or the contact service system 106 remain as separate entities. While the system 100 illustrates a configuration in a networked environment with a separate end user device, agent device, and contact service system, it should be understood that other configurations can be employed in which aspects of the various components are combined. For instance, in some aspects, aspects of the contact service system 106 can be implemented in part or in whole by the end user device 102 and/or the agent device 104.

The end user device 102 and the agent device 104 can each comprise any type of computing device capable of use by a user. For example, in one aspect, the end user device 102 and the agent device 104 may each be the type of computing device 800 described in relation to FIG. 8 herein. By way of example and not limitation, the end user device 102 and the agent device 104 can each be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user (e.g., a customer) can be associated with the end user device 102 and can interact with the contact service system 106 via the end user device 102 using the application 110. An agent user (e.g., a customer service agent) can be associated with the agent device 104 and can interact with the contact service system 106 via the agent device 104 using the application 112.

The contact service system 106 provides a platform that facilitates interactions between end users (e.g., customers) and agent users (e.g., customer service agents). For instance, the contact service system 106 can facilitate an interaction between an end user using the end user device 102 and an agent user using the agent device 104. The contact service system 106 can support a variety of different types of interactions, such as, for instance, voice chats and text chats. In accordance with aspects of the technology described herein, the contact service system 106 also facilitates simulated interactions. As will be described in further detail, this includes employing interaction data from interactions between end users and agent users to generate persona simulators and employing the persona simulators for interaction simulation.

As shown in FIG. 1, the contact service system 106 includes a tracking component 114, a scoring component 116, a prompt component 118, a generative model 120, and a simulation component 122. The components of the contact service system 106 may be in addition to other components that provide further additional functions beyond the features described herein. The contact service system 106 can be implemented using one or more server devices, one or more platforms with corresponding application programming interfaces, cloud infrastructure, and the like. While the contact service system 106 is shown separate from the end user device 102 and the agent device 104 in the configuration of FIG. 1, it should be understood that in other configurations, some or all of the functions of the contact service system 106 can be provided on the end user device 102 and/or the agent device 104. Additionally, in some configurations, one or more of the components of the contact service system 106 shown in FIG. 1 can be provided by the end user device 102, the agent device 104, and/or another location not shown in FIG. 1. The components can be provided by a single entity or multiple entities.

In some aspects, the functions performed by components of the contact service system 106 are associated with one or more applications, services, or routines. In particular, such applications, services, or routines may operate on one or more user devices, servers, may be distributed across one or more user devices and servers, or be implemented in the cloud. Moreover, in some aspects, these components of the contact service system 106 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The tracking component 114 of the contact service system 106 tracks interactions between end users and agent users and stores interaction data for the interactions in an interaction data store 124. In some aspects, the interactions comprise text-based chats between end users and agent users, and the interaction data comprises a transcript that includes the text from the chats. In other aspects, the interactions comprise voice chats between end users and agent users, and the interaction data comprises a textual transcript generated from the voice chats. For instance, transcripts can be generated from audio using automatic speech recognition (ASR), which converts spoken words from the audio into written text.

The interaction data stored in the interaction data store 124 can include additional information regarding interactions beyond transcripts. For instance, the interaction data can comprise information generated from the interactions, such as number of reconnects, time length of the interaction, sentiment, etc. The interaction data can also be tagged with an indication of the end user (e.g., an end user identifier) and an indication of one or more agent users (e.g., agent identifiers) involved in each interaction. In some aspects, the interaction data is processed using a redaction mechanism that removes any personally-identifiable information (PII) and sensitive data. This redaction can be performed before storing the interaction data in the interaction data store 124 or when retrieving interaction data from the interaction data store 124 for simulation purposes.

The scoring component 116 generates parameter scores for a number of interaction parameters based on interaction data for end users and/or agent users. The parameter scores for a given end user or a given agent user can be based on interaction data from a single interaction or multiple interactions involving that end user or agent user. In some instances, the parameters scores for some interaction parameters can be based on data independent of specific interactions between end users and agent users (e.g., the duration of an end user's or agent user's relationship with a business entity). Different types of interaction parameters can be used depending on the use case, role, domain, or purpose of interaction simulation. By way of example only and not limitation, the following is a description of some interaction parameters relevant to interaction simulation for end users:
Tenure (T): Represents the duration of the end user's relationship with the business entity.
Activity History (AH): Represents the type and value of goods traded by the end user.
Customer satisfaction score (CSAT): Represents the end user's satisfaction after interaction(s).
Number of transfers (NT): Represents the interaction escalation or redirection.
Number of recontacts (NR): Represents how often end users recontact for the same issue.
Interaction history sentiment (IHS): Represents the end user's emotion while interacting with the business entity.
Interaction history abuse (IHA): Indicates whether the end user has exhibited negative or abusive behavior.
Interaction history cost (IHC): Represents the cost associated with the end user's total interaction history, normalized by customer segment average.
Unknown (U): Refers to hidden factors like complexity or emotion.
Latent factor (L): Latent factors are random variables. It could be a factor that is known/unknown so far (e.g., ‘an act of nature’, ‘a hacked account’, etc.). This factor can be used in both model training/test phase or as a variable to further customize the model output.
Resolution (R): Refers to the successful resolution of the interaction.
Intent (I): Refers to the reason of the interaction. Some intents have different business impact.
Situation (S): Parameter that considers context, such as, for example: urgency, device, etc.

To generate parameters scores for a given end user or agent user, the scoring component 116 accesses the interaction data (and, in some cases other data) for the end user or agent user and computes each parameter score using the relevant data and an algorithm appropriate for each interaction parameter. By way of example and not limitation, the scoring component 116 can use the following techniques to determine parameter scores: multiple linear regression analysis; logistic regression; factor analysis; principal component analysis; partial least squares regression; random forests and decision trees; gradient boosting machines; neural networks; support vector machines; least absolute shrinkage and selection operator regression; expert judgement; analytic hierarchy process; Delphi method; and blended techniques.

The scoring component 116 can also determine an index score for a given end user or a given agent user as a function of the parameter scores for the end user. This is referred to herein as an end user index score in the case of an end user and an agent user index score in the case of an agent user. The index score is single non-zero indexed number that represents the end user's or agent user's overall interaction score, including the interaction quality and overall persona of the end user or agent user. For instance, a higher index score could represent a better overall quality of the interaction(s) for the end user or agent user.

In some aspects, the scoring component 116 generates an index score by applying parameter scores as weights to normalized parameter values for each interaction parameter. These weights set the baseline to the relevance of each interaction parameter in the context of the interaction(s). The normalized parameter values can be obtained using any of the following normalization techniques: min-max normalization; Z-score normalization; decimal scaling normalization; logarithmic normalization; exponential normalization; L1 normalization; L2 normalization; robust normalization; and rank normalization. These normalization techniques can be used, for instance, to convert each parameter to a standard normal distribution with a mean 0 and standard deviation of 1. To generate an index score, the scoring component 116 multiples each normalized parameter value by its respective weight (i.e., parameter score) and aggregates the resulting values. By way of example only and not limitation, the following provides an equation that can be used to determine an end user index score:

$$End User Index Score = {w}_{1} {T}^{′} + {w}_{2} {AH}^{′} + {w}_{3} {CSAT}^{′} + {w}_{4} {IHS}^{′} + {w}_{5} {I}^{′} + {w}_{6} {S}^{′} + {w}_{7} {U}^{′} + {w}_{8} {R}^{′} + {w}_{9} / ( {IHA}^{′} ) + {w}_{10} / ( {NT}^{′} ) + {w}_{11} / ( {NR}^{′} ) + {w}_{12} / ( {IHC}^{′} ) + {w}_{13} {L}^{′}$$

where wᵢ is the corresponding weight for each interaction parameter, T′ is the normalized value for the tenure parameter, AH′ is the normalized value for the activity history parameter, CSAT′ is the normalized value for the customer satisfaction score parameter, IHS′ is the normalized value for the interaction history sentiment parameter, I′ is the normalized value for the intent parameter, S′ is the normalized value for the situation parameter, U′ is the normalized value for the unknown parameter, R′ is the normalized value for the resolution parameter, IHA′ is the normalized value for the interaction history abuse parameter, NT′ is the normalized value for the number of transfer parameter, NR′ is the normalized value for the number of recontacts parameter, IHC′ is the normalized value for the interaction history cost parameter, and L′ is the normalized value for the latent factor parameter.

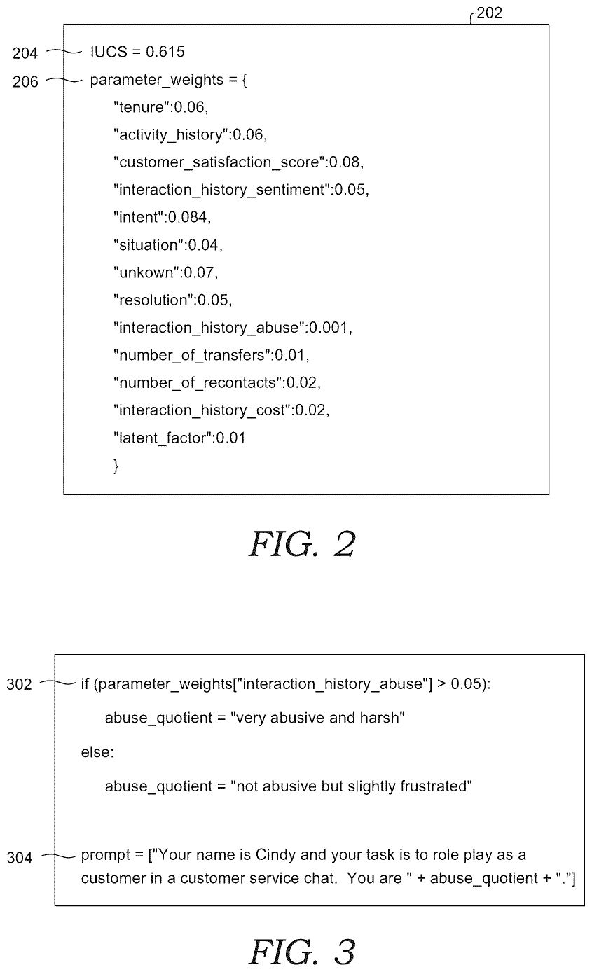

By way of illustration, FIG. 2 provides an example set of scores 202 determined for an end user based on interaction data for the end user. As shown in FIG. 2, the scores 202 include an index score 204, referenced as IUCS (Indexed User Contact Score). The scores 202 also include parameters scores in the form of parameter weights 206 for each of a number of different interaction parameters. In this example, the value of the index score 204 has been computed using the parameter weights 206 in the equation above.

The set of scores (i.e., parameter scores and/or index score) for a given end user or a given agent user define a persona for that end user or agent user. This is referred to herein as a user persona in the case of an end user and an agent persona in the case of an agent user. As will be described in further detail below, the scores defining a persona are used to generate a persona simulator for that persona. As used herein, a persona simulator refers to a generative model (e.g., the generative model 120) that has been prompted to exhibit a certain persona during simulated interactions. A persona simulator for a user persona is referred to herein as a user persona simulator, and a persona simulator for an agent persona is referred to herein as an agent persona simulator. In further aspects, an agent user can modify one or more parameter scores generated by the scoring component 116. This allows for certain aspects of a persona to be modified, thereby allowing for different simulated interactions with variations of the persona.

In some configurations, the prompt component 118 uses the parameter scores and/or index score for a given end user or a given agent user to generate one or more prompts that are provided to the generative model 120 to generate a user persona simulator or an agent persona simulator for that given end user or agent user. The prompt(s) include text that instructs or otherwise guides the generative model 120 to generate output text during simulated interactions in order to exhibit behavior in accordance with the persona.

In some aspects, the prompt component 118 generates prompts by mapping parameter scores to pre-defined text portions. For instance, the prompt component 118 can employ rules that provide definitions specifying different pre-defined text portions for different ranges of parameter scores for each interaction parameter. By way of illustration, FIG. 3 provides an example of a rule 302 that sets forth different pre-defined text portions to use for a prompt based on different ranges of parameter scores for the interaction history abuse parameter. In this example, the rule 302 specifies that if the parameter score for the interaction history abuse parameter is greater than 0.05, the pre-defined text “very abusive and harsh” is used. Otherwise, the pre-defined text “not abusive but slightly frustrated” is used. While the example in FIG. 3 provides only two ranges of parameter scores (i.e., >0.05; ≤0.05), any number of ranges can be used (e.g., three parameter score ranges: <X; ≥X and ≤Y; >Y).

The pre-defined text portions corresponding to different ranges of parameter scores can be combined with prompt templates to provide text for prompts. In such aspects, the prompt templates include placeholders for pre-defined text portions identified based on parameter scores. By way of illustration, FIG. 3 also provides an example prompt template 304 that includes a placeholder (i.e., “abuse_quotient”) for including the pre-defined text portion selected based on the parameter score for the interaction history abuse parameter. For instance, if a user's parameter score for the interaction history abuse parameter is 0.01, the rule 302 dictates use of the pre-defined text portion “not abusive but slightly frustrated”, which is combined with the prompt template 304 to provide the prompt: “Your name is Cindy and your task is to role play as a customer in a customer service chat. You are not abusive but slightly frustrated.” While FIG. 3 provides an example in which the prompt template includes a single placeholder for inserting pre-defined text for an interaction parameter; in other instances, a prompt template can include multiple placeholders for inserting pre-defined text for multiple interaction parameters. For instance, a single prompt template could be employed that includes placeholders for pre-defined text for each interaction parameter.

While FIG. 3, illustrates one approach for generating prompts, the prompt component 118 can generate prompts in any of a number of different manners. For instance, in some configurations, the prompt component 118 can access a pre-defined prompt that includes rules for selecting pre-defined text portions for parameter scores and one or more prompt templates, and the prompt component 118 adds the parameter scores (and in some cases, the index score) to the pre-defined prompt. In such aspects, the generated prompt comprises a combination of the scores, the rules, and the prompt template(s). In other configurations, the prompt component 118 executes the rules for selecting pre-defined text based on parameter scores and inserts the selected pre-defined text into placeholders of one or more prompt templates to generate one or more prompts. In such aspects, the generated prompt(s) comprise the text provided by combining the pre-defined text with the prompt template(s). In still further aspects, instead of using rules for selecting pre-defined text that is combined with prompt templates, the prompt component 118 can execute rules that select prompts with pre-defined text that does not include any placeholders. For example, a rule for the interaction history abuse parameter could provide: if the parameter score for “interaction_history_abuse”>0.05: prompt=[“Your name is Cindy and your task is to role play as a customer in a customer service chat. You are very abusive and harsh”]; else: prompt=[“Your name is Cindy and your task is to role play as a customer in a customer service chat. You are not abusive but slightly frustrated”]. Other approaches can be employed. The prompt component 118 can use a variety of different data for prompt generation, which can include, for instance, natural language text, soft prompts, embeddings, and/or templates.

In some aspects, the prompt component 118 can generate prompts that employ one-shot or few-shot prompting in which one or more transcripts are provided as examples in prompts. One-shot prompting involves providing a single example transcript, while few-shot prompting involves providing two or more example transcripts. The example transcript(s) used for a given end user or a given agent user can be from interaction(s) involving that given end user or agent user. Alternatively, the prompt component 118 can employ generic example transcript(s) for different end users or agent users (i.e., the example transcript(s) do not involve that given end user or agent user). In some configurations, the same generic example transcript(s) can be used for all end users and/or all agent users. In other configurations, the prompt component 118 can select one or more generic transcripts from a set of generic transcripts when generating a prompt for a given end user or a given agent user. For instance, the prompt data could include different generic transcripts that map to ranges of parameter scores and/or index scores, and the prompt component 118 selects one or more generic transcripts for a given end user or a given agent user based on their scores. As an example, one example transcript could be employed when the parameter score for the interaction history parameter is above a threshold (e.g., >0.05 indicating the end user is “very abusive and harsh”), and another example transcript could be employed when the parameter score for the interaction history parameter is below the threshold (e.g., <0.05 indicating that the end user is “not abusive but slightly frustrated”). In that case, the first example transcript could provide an example of an end user who is “very abusive and harsh”, while the second example transcript could provide an example of an end user who is “not abusive but slightly frustrated.”

The example transcripts used in one-shot or few-shot prompting guide the generative model 120 in generating relevant text to simulate interactions between end users and agent users. For instance, the examples can serve as a template, showcasing the expected format, tone, or style expected for the output from the generative model 120. The example transcripts act as a clear reference point, helping the generative model infer patterns and produce coherent, contextually appropriate responses.

As shown in FIG. 1, the contact service system 106 includes a prompt data store 126. The prompt data store 126 serves as a repository of various data used by the prompt component 118 to generate prompts based on scores. This can include, for instance, rules setting forth pre-defined text for parameter scores, prompt templates, example transcripts and other data that can be used by the prompt component 118 to generate prompts. Different prompt data can be provided for different purposes. For instance, certain prompt data can be employed for end users; while other prompt data can be employed for agent users. Accordingly, the prompt component 118 can select certain prompt data from the prompt data store 126 to generate a prompt for a given end user or a given agent user based on, for instance, the user role, parameter scores, index score, and/or other factors.

The generative model 120 can comprise a language model that includes a set of statistical or probabilistic functions to perform Natural Language Processing (NLP) in order to understand, learn, and/or generate human natural language content. For example, a language model can be a tool that determines the probability of a given sequence of words occurring in a sentence or natural language sequence. Simply put, it can be a model that is trained to predict the next word in a sentence. A language model is called a large language model (LLM) when it is trained on enormous amount of data and/or has a large number of parameters. Some examples of LLMs are GOOGLE's BERT and OpenAI's GPT-4. These models have capabilities ranging from writing a simple essay to generating complex computer codes—all with limited to no supervision. Accordingly, an LLM can comprise a deep neural network that is very large (billions to hundreds of billions of parameters) and understands, processes, and produces human natural language by being trained on massive amounts of text. These models can predict future words in a sentence letting them generate sentences similar to how humans talk and write.

In accordance with some aspects, the generative model 120 comprises a neural network (i.e., an artificial neural network). As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some configurations, the generative model 120 is a pre-trained model (e.g., a pre-trained LLM) that has not been fined-tuned. In other configurations, the generative model 120 is a model that is built and trained from scratch or a pre-trained model that has been fine-tuned. In such configurations, the generative model 120 can be trained or fine-tuned using training data. For instance, the generative model 120 could be trained on example transcripts such that, once trained, the generative model 120 is optimized for generating text for simulated interactions. This could be in addition to, or in lieu of, one-shot or few-shot prompting. During training, weights associated with each neuron can be updated. Originally, the generative model 120 can comprise random weight values or pre-trained weight values that are adjusted during training. In one aspect, the generative model is trained using backpropagation. The backpropagation process comprises a forward pass, a loss function, a backward pass, and a weight update. This process is repeated using the training data. For instance, each iteration could include providing an input to the generative model 120, generating an output text string by the generative model 120, computing a loss based on the output text string, and updating parameters (e.g., weights) of the generative model 120 based on the computed loss. The goal is to update the weights of each neuron (or other model component) to cause the generative model 120 to produce particular forms of output. Once trained, the weight associated with a given neuron can remain fixed. The other data passing between neurons can change in response to a given input. Retraining the network with additional training data can update one or more weights in one or more neurons.

The simulation component 122 of the contact service system 106 facilitates simulated interactions involving user persona simulators and/or agent persona simulators. For a given end user or a given agent user, the simulation component 122 provides one or more prompts from the prompt component 118 as input to the generative model 120 to provide a persona simulator (i.e., a user persona simulator or an agent persona simulator). As such, the persona simulator comprises the generative model 120 instructed by the prompt(s) from the prompt component 118 to exhibit behavior based on the persona captured by the prompt(s). As discussed above, the prompt(s) from the prompt component 118 have been generated based on the scores for the end user or agent user such that the prompt(s) instruct or otherwise guide the generative model 120 to interact in a manner consistent with the persona of that end user or agent user.

Each simulated interaction facilitated by the simulation component 122 involves at least two participants—an end user and an agent user—in which a persona simulator acts as at least one of the participants. In some aspects, the simulation component 122 facilitates a simulated interaction between an agent user via an agent device, such as the agent device 104, and a persona simulator. In some instances, a user persona simulator acts as the end user of the simulated interaction and the agent user at the agent device 104 acts as the agent user of the simulated interaction. In other instances, an agent persona simulator acts as the agent user of the simulated interaction and the agent user at the agent device 104 acts as the end user. In either case, the simulation component 122 provides a chat interface to the agent device 104 (e.g., presented by the application 112) that presents text generated by the persona simulator and allows the agent user at the agent device 104 to enter text. During the simulated interaction, the simulation component 122 provides text entered by the agent user at the agent device 104 as input to the persona simulator, and the text generated by the persona simulator is presented in the chat interface. The simulation component 122 can store a transcript of the simulated interaction between the persona simulator and the agent user at the agent device 104 for further analysis.

In other aspects, the simulation component 122 facilitates a simulated interaction component between two persona simulators. In such instances, a user persona simulator acts as the end user of the simulated interaction, and an agent persona simulator acts as the agent user of the simulated interaction. During the simulated interaction, the simulation component 122 provides text generated by the user persona simulator as input to the agent persona simulator and provides text generated by the agent persona simulator as input to the user persona simulator. The simulation component 122 can store a transcript of the simulated interaction between the user persona simulator and the agent persona simulator for further analysis.

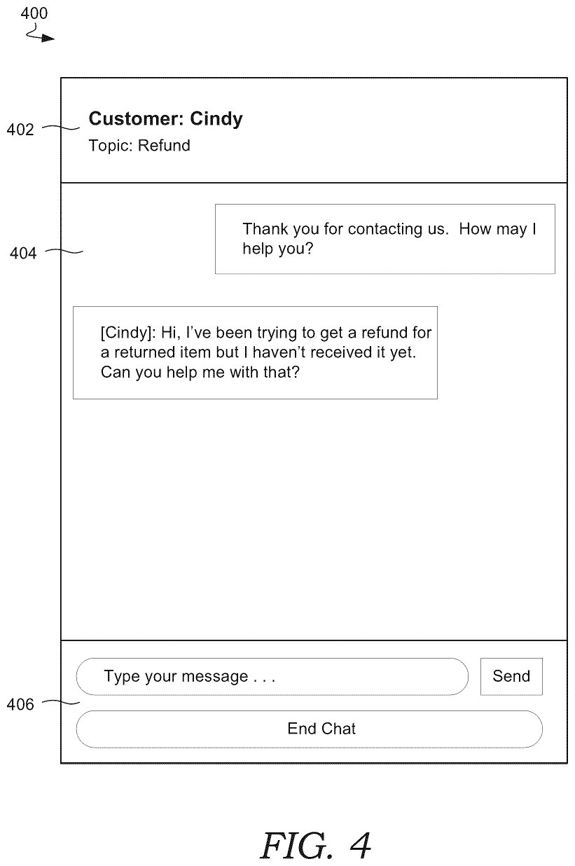

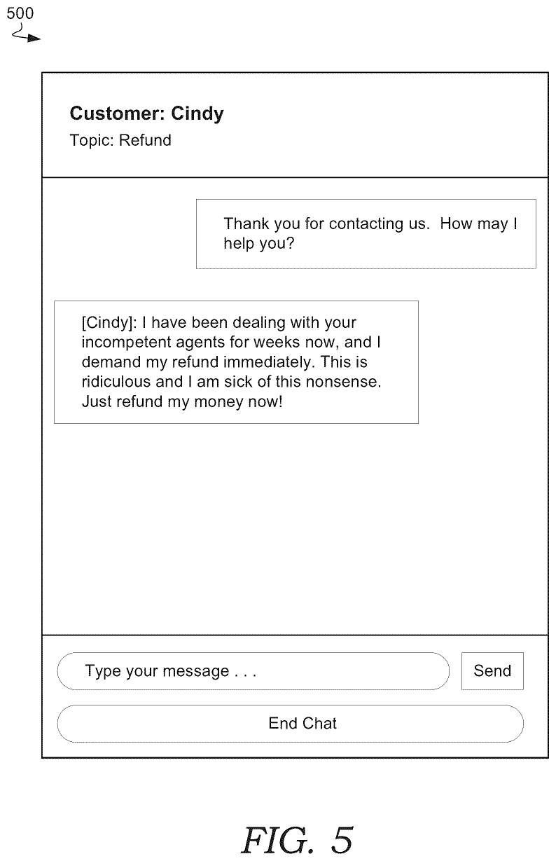

By way of illustration, FIGS. 4 and 5 provide examples of chat interfaces that can be presented on an agent device, such as agent device 104, to allow an agent user to interact with a user persona simulator during a simulated interaction. In the examples of FIGS. 4 and 5, the user persona simulator acts as the end user of the simulated interaction and the agent user at the agent device acts as the agent user of the simulated interaction.

With initial reference to FIG. 4, a chat interface 400 is illustrated that is similar to conventional chat interfaces for agent users. The chat interface 400 includes a header area 402 that provides the customer's name and topic (e.g., the customer's issue). In this example, the customer “Cindy” is provided by a user persona simulator that has been generated by providing one or more prompts for a user persona to a generative model. The chat interface 400 also includes a conversation area 404 that presents the text of the conversation between the agent user and the user persona simulator. The chat interface 400 further includes an area 406 allowing the agent user to enter text during the simulated interaction, as well as allowing the agent user to end the simulated interaction. When the agent user enters text, the text is provided as input to the user persona simulator, which generates a text output that is presented as text from the end user during the simulated interaction. While FIG. 4 presents an example in which only a single message has been provided by each of the agent user and the user persona simulator, a simulated interaction can include any number of back and forth messages between an agent user and a persona simulator.

FIG. 4 provides an example in which the interaction history abuse score for the end user is less than a threshold, such that the generative model has been prompted to act as a user who is “not abusive but slightly frustrated.” As such, the text generated by the user persona simulator and presented in the chat interface 400 (i.e., the text identified as from [Cindy]) is “not abusive but slightly frustrated.” FIG. 5 provides a chat interface 500 similar to the chat interface 400 in FIG. 4. However, FIG. 5 provides an example in which the interaction history abuse score for the end user is above the threshold, such that the generative model has been prompted to act as a user who is “very abusive and harsh.” As such, the text generated by the user persona simulator and presented in the chat interface 500 (i.e., the text identified as from [Cindy]) is “very abusive and harsh.”

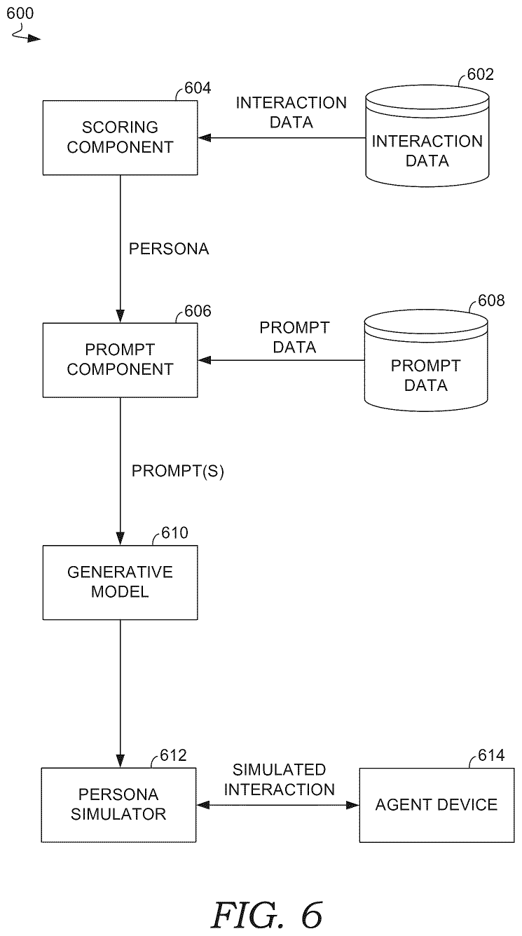

Turning next to FIG. 6, a block diagram is provided that illustrates an overall process 600 that can be implemented, for instance, by the system 100 to generate a persona simulator and employ the persona simulator for a simulated interaction. As shown in FIG. 6, interaction data for an end user or an agent user is accessed from an interaction data store 602 at a scoring component 604 (which can correspond to the scoring component 116 of FIG. 1). Based on the interaction data, the scoring component 604 determines scores (i.e., parameter scores and/or index score) that defines the persona for the end user or the agent user. The scores are provided to a prompt component 606 (which can correspond to the prompt component 118 of FIG. 1). Based on the scores and prompt data from a prompt data store 608, the prompt component 606 generates one or more prompts. The prompt(s) are provided as input to a generative model 610 to produce a persona simulator 612 (i.e., a user persona simulator in the case of an end user or an agent persona simulator in the case of an agent user). The persona simulator 612 is then employed to conduct a simulated interaction. In the example of FIG. 6, the simulated interaction is with an agent user via an agent device 614. However, in other instances, the simulator interaction can be between the persona simulator 612 and another persona simulator (e.g., a simulated interaction between a user persona simulator and an agent persona simulator).

### Example Method for Automated Persona Simulations

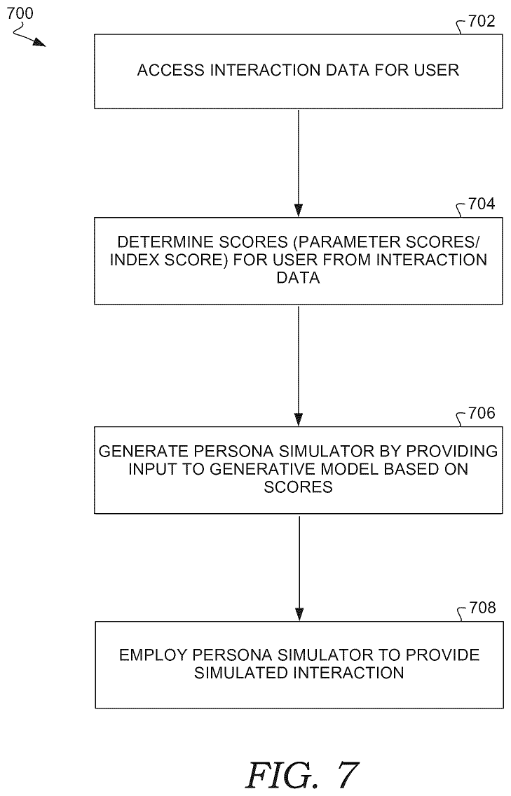

With reference now to FIG. 7, a flow diagram is provided that illustrates a method 700 for generating a persona simulator and employing the persona simulator for a simulated interaction. The persona simulator can be a user persona simulator generated for an end user or an agent persona simulator generated for an agent user. As such, the term “user” in the context of FIG. 7 refers to an end user or an agent user.

The method 700 can be performed, for instance, at least in part by the components of the contact service system 106 of FIG. 1. Each block of the method 700 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 702, interaction data for a user (i.e., either an end user or an agent user) is accessed. The interaction data is based on one or more interactions involving the user. In the case of an end user, the interaction data is based on one or more interactions between the end user and one or more agent users. In the case of an agent user, the interaction data is based on one or more interactions between the agent user and one or more end users. In some instances, the interaction data comprises text from transcript(s) of the interaction(s).

Parameter scores for a number of interaction parameters are determined based on the interaction data, as shown at block 704. In some aspects, an index score is also determined for the user as a function of the parameter scores. The scores provide a persona for the user (i.e., a user persona in the case of an end user; or an agent persona in the case of an agent user).

As shown at block 706, a persona simulator is generated for the persona by providing an input to a generative model based on the parameter scores (and index score in some configurations). This provides a user persona simulator in the case of an end user and an agent persona simulator in the case of an agent user. In some cases, an agent user can modify one or more parameter scores to modify the persona as desired (e.g., modifying the parameter score for the interaction history abuse to make the persona more abusive or less abusive).

In some aspects, the input to the generative model comprises one or more prompts generated based on the parameter scores. For instance, the system can use rules to select one or more pre-defined text portions based on the parameter scores, where the one or more prompts include the one or more pre-defined text portions. In some instances, one-shot or few-shot prompts are employed in which the one or more prompts include one or more transcript examples. The transcript example(s) can be transcript(s) from interactions involving the user or generic transcript(s) (e.g., transcript(s) from interactions involving other user(s)).

The persona simulator is employed to provide a simulated interaction, as shown at block 708. In some aspects, the simulated interaction is between the persona simulator and an agent user. For instance, in the case of a user persona simulator for an end user, the simulated interaction can involve an agent user acting as the agent user and the user persona simulator acting as an end user during the simulation. In the case of an agent persona simulator for an agent user, the simulated interaction can involve the agent persona simulator acting as the agent user and an agent user acting as an end user during the simulation. In either case, text entered by the agent user is provided as input to the persona simulator, which generates text that is presented in the chat interface used by the agent user. The simulated interaction can involve back and forth text messages between the agent user and persona simulator until the interaction is completed or otherwise ended.

In some other aspects, two persona simulators are generated - a user persona simulator and an agent persona simulator. In such aspects, the simulated interaction can be between the user persona simulator and the agent persona simulator in which text generated by the user persona simulator is provided as input to the agent persona simulator and text generated by the agent persona simulator is provided as input to the user persona simulator. The simulated interaction can involve back and forth interaction between the user persona simulator and the agent persona simulator until the interaction is completed or otherwise ended.

### Exemplary Operating Environment

Having described implementations of the present disclosure, an exemplary operating environment in which embodiments of the present technology may be implemented is described below in order to provide a general context for various aspects of the present disclosure. Referring initially to FIG. 8 in particular, an exemplary operating environment for implementing embodiments of the present technology is shown and designated as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 may be equipped with depth cameras, such as, stereoscopic camera systems, infrared camera systems, RGB camera systems, and combinations of these for gesture detection and recognition. Additionally, the computing device 800 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
accessing interaction data for an end user from one or more interactions between the end user and one or more agent users;
determining, from the interaction data, a set of parameter scores for a plurality of interaction parameters to provide a user persona for the end user;
generating a user persona simulator for the user persona by providing an input to a generative model based on the set of parameter scores; and
causing the user persona simulator to provide a simulated interaction.

2. The one or more computer storage media of claim 1, wherein the interaction data comprises text from a transcript for each of the one or more interactions.

3. The one or more computer storage media of claim 1, wherein the operations further comprise:
determining a user index score from the set of parameter scores; and
wherein the input to the generative model is further based on the user index score.

4. The one or more computer storage media of claim 1, wherein generating the user persona simulator by providing the input to the generative model based on the set of parameter scores comprises:
generating one or more prompts using one or more rules to select a plurality of pre-defined text portions based on the set of parameter scores; and
providing the one or more prompts as the input to the generative model to generate the user persona simulator.

5. The one or more computer storage media of claim 1, wherein the one or more prompts comprise one or more transcript examples.

6. The one or more computer-storage media of claim 5, wherein the one or more transcript examples are from the one or more interactions between the end user and the one or more agent users.

7. The one or more computer-storage media of claim 1, wherein the simulated interaction is with an agent user, and wherein the user persona simulator generates responses to inputs provided by the agent user.

8. The one or more computer storage media of claim 1, wherein the operations further comprise:
receiving input indicative of a modified parameter score for a first interaction parameter from the plurality of interaction parameters; and
generating a modified user persona simulator by providing a second input to the generative model based on the modified parameter score for the first interaction parameter.

9. The one or more computer storage media of claim 1, wherein the operations further comprise:
accessing second interaction data for an agent user from one or more interactions between the agent user and one or more end users;
determining, from the second interaction data, a second set of parameter scores for a second plurality of interaction parameters to provide an agent persona for the agent user; and
generating an agent persona simulator for the agent persona by providing an input to a second generative model based on the second set of parameter scores.

10. The one or more computer storage media of claim 9, wherein the simulated interaction is between the user persona simulator and the agent persona simulator in which output from the user persona simulator is provided as input to the agent persona simulator and output from the agent persona simulator is provided as input to the user persona simulator.

11. A computer-implemented method comprising:
accessing interaction data for an agent user from one or more interactions between the agent user and one or more end users;
determining, from the interaction data, a set of parameter scores for a plurality of interaction parameters to provide an agent persona for the agent user;
generating an agent persona simulator for the agent persona by providing an input to a generative model based on the set of parameter scores; and
causing the agent persona simulator to provide a simulated interaction.

12. The computer-implemented method of claim 11, wherein the method further comprises:
determining an agent index score from the set of parameter scores; and
wherein the input to the generative model is further based on the agent index score.

13. The computer-implemented method of claim 11, wherein generating the agent persona simulator by providing the input to the generative model based on the set of parameter scores comprises:
generating one or more prompts using one or more rules to select a plurality of pre-defined text portions based on the set of parameter scores; and
providing the one or more prompts as the input to the generative model to generate the agent persona simulator.

14. The computer-implemented method of claim 13, wherein the one or more prompts comprise one or more transcript examples.

15. The computer-implemented method of claim 14, wherein the one or more transcript examples are from the one or more interactions between the agent user and the one or end users.

16. The computer-implemented method of claim 11, wherein the simulated interaction is with a second agent user, and wherein the agent persona simulator generates responses to inputs provided by the second agent user.

17. The computer-implemented method of claim 11, wherein the method further comprises:
receiving input indicative of a modified parameter score for a first interaction parameter from the plurality of interaction parameters; and
generating a modified agent persona simulator by providing a second input to the generative model based on the modified parameter score for the first interaction parameter.

18. A computer system comprising:
one or more processors; and
one or more computer storage media storing computer-usable instructions that, when used by the one or more processors, cause the computer system to perform operations comprising:
generating a user persona simulator by:
determining, from interaction data for an end user, a set of parameter scores for a plurality of interaction parameters to provide a user persona for the end user, and
generating the user persona simulator for the user persona by providing an input to a generative model based on the set of parameter scores;
generating an agent persona simulator by:
determining, from interaction data for an agent user, a second set of parameter scores for a second plurality of interaction parameters to provide an agent persona for the agent user, and
generating the agent persona simulator for the agent persona by providing a second input to a second generative model based on the second set of parameter scores; and
causing the user persona simulator and the agent persona simulator to provide a simulated interaction in which output from the user persona simulator is provided as input to the agent persona simulator and output from the agent persona simulator is provided as input to the user persona simulator.

19. The computer system of claim 18, wherein generating the user persona simulator by providing the input to the generative model based on the set of parameter scores comprises:
generating one or more prompts using one or more rules to select a plurality of pre-defined text portions based on the set of parameter scores; and
providing the one or more prompts as the input to the generative model to generate the user persona simulator.

20. The computer system of claim 18, wherein generating the agent persona simulator by providing the second input to the second generative model based on the second set of parameter scores comprises:
generating one or more prompts using one or more rules to select a plurality of pre-defined text portions based on the second set of parameter scores; and
providing the one or more prompts as the second input to the second generative model to generate the agent persona simulator.
